(19) United States
(12) Patent Application Publication
(10) Pub. No.: US 2005/0216523 A1
(43) Pub. Date: Sep. 29, 2005

(54) File management method in a distributed storage system

(76) Inventors: Akihiko Sakaguchi, Tokyo (JP); Toru Takahashi, Kamakura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/903,006

(22) Filed: Aug. 2, 2004

(30) Foreign Application Priority Data
Mar. 26, 2004 (JP) 2004-092060

(51) Int. Cl. G06F 17/30

(52) U.S. Cl. 707/201

(57) ABSTRACT

Provided is a technique that effectively utilizes a replication to reduce inquiries to a location database, and thus allow data access at a high speed. According to this technique, a plurality of storage systems arranged in a distributed fashion are allocated to a plurality of groups, a file management database indicating locations of all the files in the storage systems belonging to the groups is synchronized between storage systems of the same group, and when file access is made to the group, a storage system storing the file is determined based on the file management database, thus being accessed. When an access request is for an update, the writing to the file is performed, and a replica of the file that has been written is transferred to a storage system in a different group.

### CROSS-REFERENCE TO RELATED APPLICATION

This application related to a U.S. application Ser. No. 10/834,866 filed on Apr. 30, 2004, entitled “File Management Method in A Distributed Storage System”, the disclosure of which is hereby incorporated by reference into this application.

### CLAIM OF PRIORITY

The present application claims priority from Japanese application P2004-92060 filed on Mar. 26, 2004, the content of which is hereby incorporated by reference into this application.

### BACKGROUND

This invention relates to improvement of a distributed storage system in which disk drives are arranged in a distributed manner, and files stored in the disk drives are shared through a network.

As a client/server type distributed storage system (or equipment), the Andrew File System (hereinafter referred to as AFS) is known (Non-Patent Literature 1).

This system is a system that gives each file an identifier having a location field in it, acquires a location of this file from information of its location field, and accesses to an object file. For this purpose, a location database for managing location fields is installed on an arbitrary site on a network, and when an client accesses a file, the client inquires the location field included in the identifier from the location database, and accesses to the location that the location database replied.

Moreover, a file that was accessed once is cached by a storage system, a cache server, or the like, which improves an access speed thereto next time and thereafter.

[Non-Patent Literature 1]
“Kernel of the most advanced UNIX” (Japanese translation), pp. 373-374 and 376 written by Uresh Vahalia, translated by Hideyuki Tokuda, Yoshito To be, and Etsuyuki Tsuda, published by Pearson Education Japan in May 15, 2000 (The Original, “UNIX Internals: The New Frontiers,” by Prentice Hall, Inc. 1996).

### SUMMARY

However, in the conventional example, when a local storage system has a file, the file can be read or written quickly, but when the local storage system does not have the file, the client will inquire its location from the location database, receive a reply from the location database, and do remote access to an object storage system; consequently, there is a problem that this remote access cannot be made quickly.

Moreover, in the case where the client accesses to a cache by remote access, since exclusive control of access is mandatory in order to ensure consistency of data, there is a problem that availability is lowered. For example, when there are a plurality of WRITE requests to the same file, the system will accept an earliest WRITE request from a client and refuse subsequent WRITE requests.

Furthermore, when making backups of each of the storage systems, the original data in the storage system serving as a reference is replicated by being copied into other storage systems which are located remotely. However, when the inquiry is made to the location database, the storage system where the original data was stored is always designated. Therefore, there was a problem in that even if the replication is present in the most proximate storage system, the replication cannot be used.

Thus, this invention was made in light of the above-mentioned problems, and it is therefore an object of this invention to effectively utilize a replication, to reduce inquiries to a location database, and thus allow data access at a high speed.

According to this invention, a plurality of storage systems arranged in a distributed manner are allocated to a plurality of groups, file management information indicating locations of all the files in the storage systems belonging to the groups is synchronized between storage systems of the same group, and when file access is made to the group, a storage system storing the file is determined based on the file management information, thus being accessed.

Further, when an access request is for an update, the writing to the file is performed, and a replica of the file that has been written is transferred to a storage system in a different group.

Therefore, according to this invention, by synchronizing the file management information in each group, access requests for accessing the distributed replication system can be processed when made to any storage system, and can be prevented from concentrating on a particular system.

In addition, the storage systems in each group have the same synchronized file management information. Accordingly, no matter which storage system the failure occurs in, the file management information of a storage system in the same group may be used to perform the recovery easily and rapidly. This improves the reliability of the distributed replication system.

Then, the replicas from the other groups are stored in each group and can be provided in response to access requests. This prevents the access request from being issued to many groups, and thus improves an access speed.

Furthermore, storing the replicas into the other groups improves failure resistance and improves the reliability of the distributed replication system.

### BRIEF DESCRIPTION OF THE DRAWINGS

FIG. 1 is a block of a computer system according to an embodiment of this invention.

FIG. 2 is an explanatory diagram showing a group management server and respective storage system groups.

FIG. 3 is an explanatory diagram showing a sequence of updating a file.

FIG. 4 is an explanatory diagram showing the content of a file management database.

FIG. 5 is another explanatory diagram showing the content of the group management database.

FIG. 6 is a screen image showing addition of a storage system to a group.

FIG. 7 is a flowchart showing a processing sequence performed in response to a file access request.

FIG. 8 is an explanatory diagram showing a sequence of adding the storage system to the group.

FIG. 9 is an explanatory diagram showing a sequence of deleting the storage system from the group.

FIG. 10 is an explanatory diagram showing a sequence of migrating the storage system between groups.

FIG. 11 is a flowchart showing an example of processing performed at a group management server, when the storage system is moved between groups.

FIG. 12 is an explanatory diagram showing a sequence of recovering a storage system where a failure has occurred.

FIG. 13 is an explanatory diagram of a case where replication management is performed at the group management server.

FIG. 14 is an explanatory diagram of providing a subset of the group management database is provided to the storage system.

FIG. 15 is an explanatory diagram showing a sequence of performing a volume-based replication between storage systems.

FIG. 16 is an explanatory diagram showing another sequence of performing volume-based replication between storage systems.

### DETAILED DESCRIPTION OF THE PREFERRED EMBODIMENTS

Hereinafter, explanation will be given regarding an embodiment of this invention, based on the attached drawings.

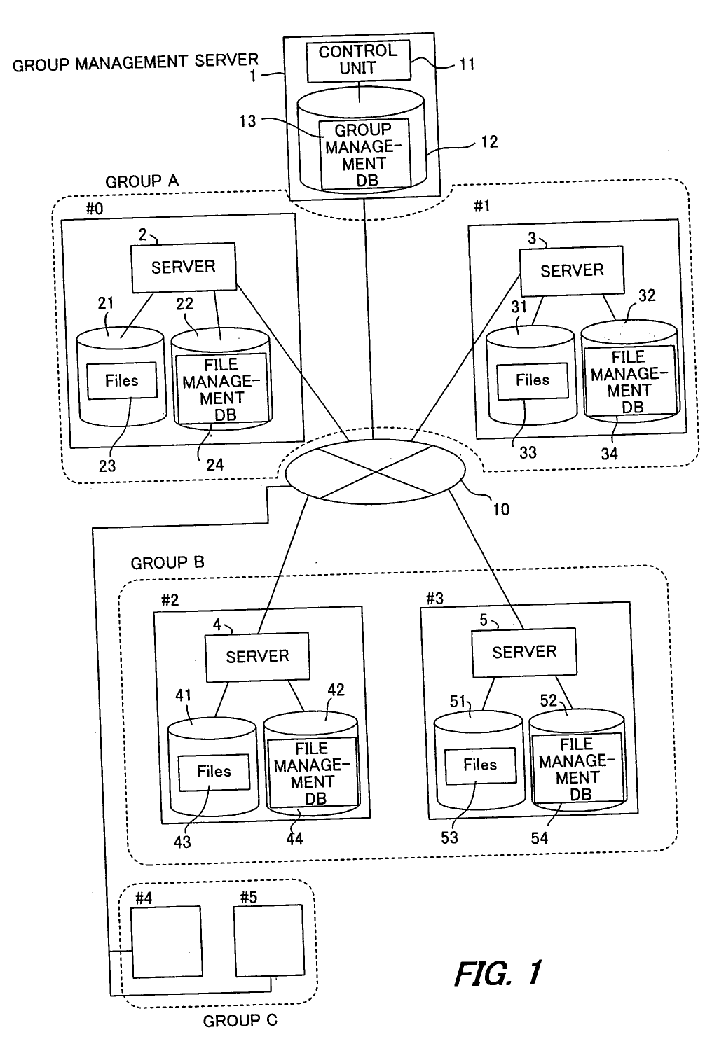

FIG. 1 is a structure diagram of a distributed storage system (distributed replication system) to which this invention is applied. FIG. 1 shows an example in which many storage systems #0-#5 and a group management server (or NIS server) 1 are connected via a network 10, constructing the distributed replication system. It should be noted that the network 10 indicates the Internet, a WAN, a LAN, or the like.

The storage system #0 is provided with a disk drive 21 storing a file 23 as data, and a disk drive 22 storing a file management database 24 that manages the storage locations of files stored in the disk drive 21 and the files stored in the storage systems in the same group. These disk drives 21 and 22 are controlled by a server 2.

Then, the server 2 responds to a read request or an update request from a client computer (not shown) or from another server or storage system, and reads or updates the file 23 in the disk drive 21.

The other storage systems #1-#5 are constituted similarly. In the storage system #1, a server 3 controls a file 33 in disk drives 31 and 32 and a file management database 34. In the storage system #2, a server 4 controls a file 43 in disk drives 41 and 42 and a file management database 44. In the storage system #3, a server 5 controls a file 53 in disk drives 51 and 52 and a file management database 54. It should be noted that the storage systems #4 and #5 have similar constructions, so that details thereof are omitted. It should also be noted that the servers 2-5 are each provided with a CPU (not shown), a memory (not shown), and an interface (not shown).

The group management server 1 has a CPU, a memory, an interface, and the like constituting a control unit 11, and a disk drive 12. The disk drive 12 stores a group management database 13 that manages the respective storage systems #0-#5 in multiple groups.

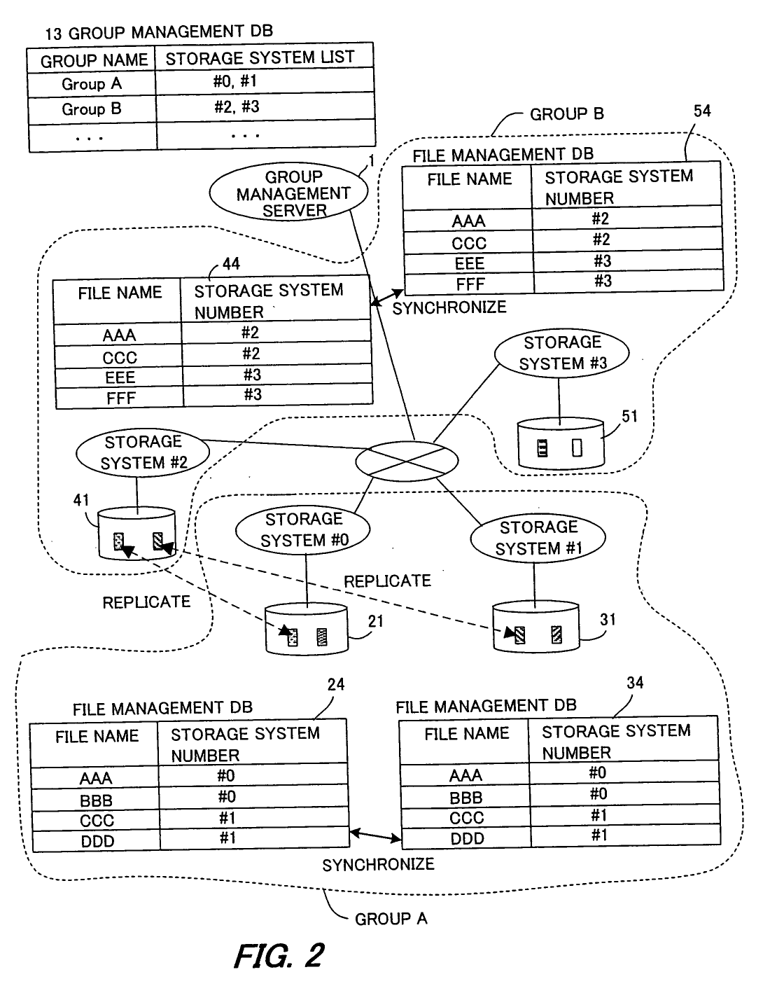

The group management server 1 manages the many storage systems #0-#5 in terms of pre-set multiple groups, and thus, as shown in FIG. 2, by using the group management database 13 where storage system identifiers (numbers) are associated with each group name, the storage systems are each allocated to pre-set groups.

FIG. 1 shows a case in which the storage systems #0 and #1 are allocated to a group A, the storage systems #2 and #3 are allocated to a group B, and the storage systems #4 and #5 are allocated to a group C.

The file management databases 24, 34, 44, and 54 are used to synchronize the locations (directory paths, etc.) of all the data (files), between physically different storage systems within each group.

Then, between the groups, the replication is transferred to another group, and the location of the transferred replication is also held in the file management databases 24, 34, 44, and 54, and intra-group synchronization is also performed. The location for the replication is set in advance for each storage system, or is set in advance for in the group management server 1.

For example, in FIG. 2, the storage systems #0 and #1 in the group A replicate to the storage system #2 in the group B. Then, the replication of the files in the group A are written in the file management databases 44 and 54 in the group B. Therefore, when responding to the file read request, in addition to the original file, the replication can also be used. This reduces the time required to access the file, and can accelerate access.

Hereinafter, with reference to FIG. 2, detailed explanation will be given regarding sharing of the data location (hereinafter, referred to as “file location”), and the generation and transfer of the replication, which are performed between the groups A and B.

First, the group management server 1 is provided with the group management database 13, which manages the group settings, the storage systems belonging to each group, and the orders.

The group management database 13 stores groups that have been pre-set by an administrator or the like, storing the storage systems that belong to each group. In FIG. 2, belonging to the group A are the storage systems #0 and #1, in this order. Belonging to the group B are the storage systems #2 and #3, in this order. As the storage system identifiers which are stored in the group management database 13, for example, as shown in FIG. 5, the IP addresses of the storage systems are stored in a predetermined order. It should be noted that instead of the IP addresses, the identifiers may also be MAC addresses or other such identifiers which are determined uniquely on the network.

The storage system written in the header of each group indicates the storage system that represents the group. As explained below, the group management database 13, upon receiving the read request or the update request, responds that the inquiry should be made to the header storage system which is stored in the head group.

In FIG. 2, at the storage systems #0-#3, the file management databases 24, 34, 44, and 54 operate on the servers 2-5, respectively, and the file management databases of each storage system in the same group are synchronized to each other, and the content of the file management databases in the same group hold equivalent content. That is, within the same group, the file management databases are shared.

For example, in the group A which is constituted by the storage systems #0 and #1, the file management databases 24 and 34 in the storage systems #0 and #1 have identical content, and when the file 23 in the disk drive 21 in the storage system #0 is modified, the file management database 24 is updated and also the file management database 34 of the other storage system #1 in the same group is also updated to the same information, thus obtaining mutual synchronization.

Furthermore, as shown in FIG. 2, looking at the group A, files “AAA” and “BBB” are stored in the disk drive 21 of the storage system #0, and files “CCC” and “DDD” are stored in the disk drive 31 of the storage system #1. The file management databases 24 and 34 in the group A have the storage system number “#0”, which corresponds to the file name “AAA”, set as the file identifier. Similarly, the storage system number “#0” corresponding to the file name “BBB”, the storage system number “#1” corresponding to the file name “CCC”, and the storage system number “#1” corresponding to the file name “DDD” are set respectively.

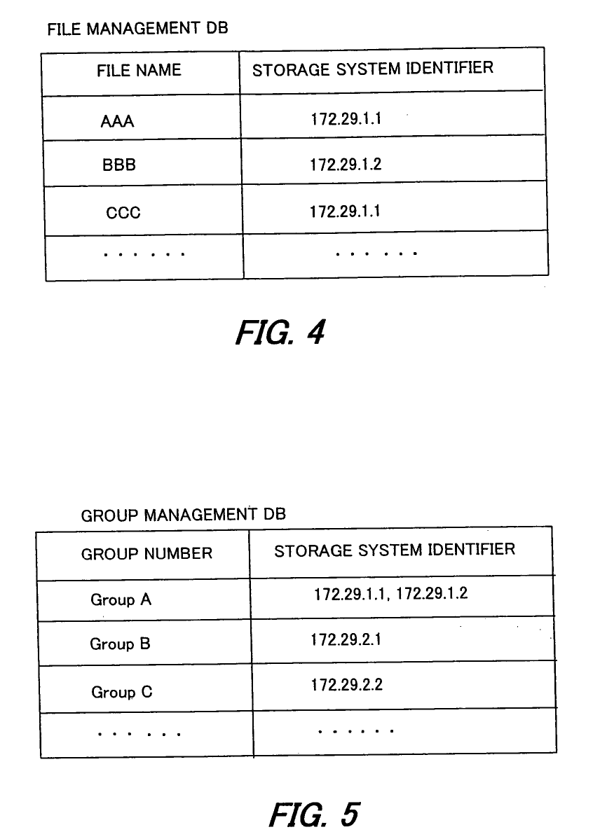

Then, in order to make the file management databases 24 and 34 have the same content, synchronization is established when a modification occurs to the files in the group A. Therefore, the files 23 and 33 being stored by the storage systems #0 and #1, respectively, are different, but the file management databases 24 and 34 hold storage system information (identifiers indicating locations) for all the file names in the group A. As the identifiers showing these file locations, a location is shown where the file name and the IP address are associated and stored as a single record, as shown in FIG. 4.

The file management databases 44 and 54 of the storage systems #2 and #3, respectively, in the group B are similar. The location information of files “EEE” and “FFF”, which are stored in the storage system #3, are held in an equivalent manner.

Thus, when searching for a file, if the file is within the same group, the same response is given regardless of which storage system is inquired to. However, in order to receive access from the client computer or from another group or the like, it is necessary to set which storage system within the same group the inquiry may be made to. Therefore, the storage system written in each group header of the group management database 13 serves as the storage system that represents that group. When the representative storage system undergoes downtime, access is then made to the next storage system written in the group management database 13 instead.

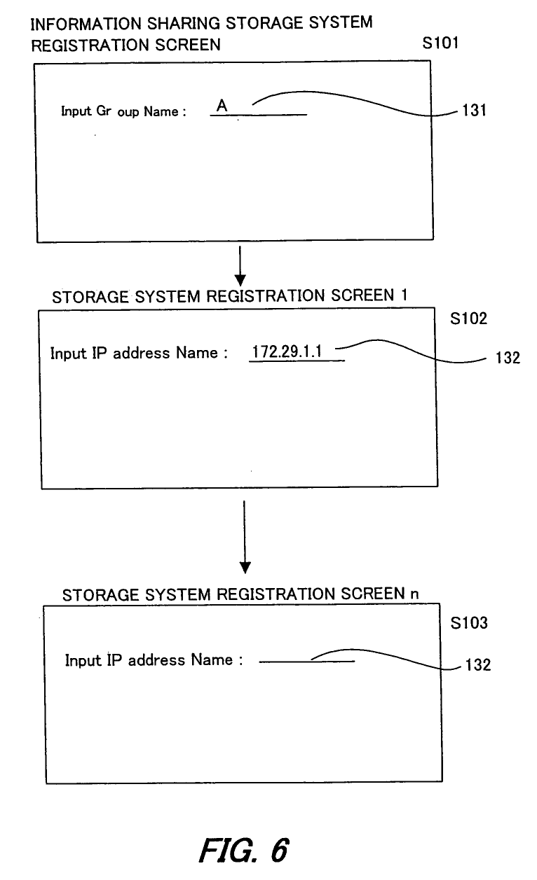

Here, FIG. 6 will be referenced as explanation will be given regarding registration of the group and the storage systems.

FIG. 6 shows an image of a display on a console (not shown) of the group management server 1.

First, a predetermined operation is performed to call up a screen S101 for inputting a group name to be registered into the storage system. A desired group name is inputted into a group input field 131 on the screen.

Next, the screen moves to a screen for registering an identifier for the storage system (S102). In an identifier input field 132, the identifier for the storage system (here, the IP address) is inputted. Finally, return is inputted in the identifier input field 132, and the processing ends (S103).

When registering multiple storage systems into the same group, IP addresses are inputted multiple times at S102.

By performing the above-mentioned operations, the storage system can be allocated to a group in the group management database 13.

<Updating Files>

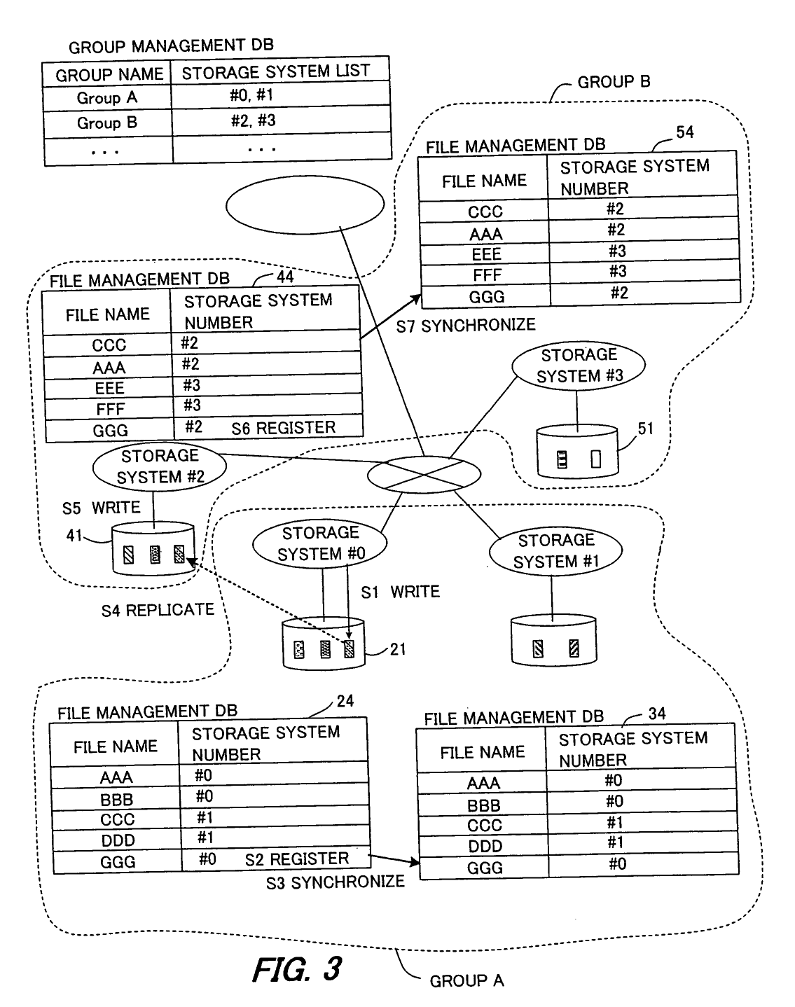

Next, referring to FIG. 3, explanation will be given regarding operations of each storage system when there is a file update request. It should be noted that FIG. 3 is an explanatory diagram showing a flow of data.

FIG. 3 shows a case where a file with the file name “GGG” is added to the storage system #0 in the group A.

The storage system #0 receives the update request for the file with the file name “GGG” from the client computer or the like, which is not shown in the diagram, and writes the file “GGG” into the disk drive 21 (S1).

The file management database 24 of the storage system #0, once the file “GGG” has been added, creates a record for the file name “GGG”, and then writes #0 into the corresponding storage system number, and thus registers the file “GGG” (S2). It should be noted that since the file “GGG” is an original file, it is possible to add information indicating that the file is original into the file management database 24, although such is not shown in the diagram.

The file management database 24, where the new file “GGG” has been registered, notifies the other storage system (#1) in the same group that the file management database has been modified, and sends the content of the modification (the file name and the storage system number), and synchronizes the file management databases within the group (S3). Accordingly, all of the file management databases 24 and 34 within the group A then have the same content.

Next, the storage system #0, once the file has been added thereto, transfers the replication to the pre-set transferring destination (here, this is the storage system #2) (S4).

The storage system #2 that received the replication adds the file “GGG” to its own disk drive 41 (S5).

The file management database 44 of the storage system #2, once the file “GGG” has been added, creates a record for the file name “GGG”, writes its own device number #2 into the corresponding device number, and thus registers the file “GGG” (S6). The file management database 44, where the new file “GGG” has been registered, then notifies the other storage system (#3) within the same group B that the file management database has been modified, sends the content of the modification (the file name and storage system number), and then synchronizes the file management databases within the group (S7). Accordingly, all of the file management databases 44 and 54 within the group B then have the same content.

Here, the storage system #2 that received the replication in the group B then registers the replication into the file management database 24 similarly to the original, thus improving the access speed of the read request to the distributed replication system. Namely, the group management server 1, in response to the access request, sequentially provides the groups in the group management database 13, and also makes the locations where the replications are stored able to read, thus reducing the number of access times (number of inquiries).

However, at the location where the replication is saved, in order to keep the replication from being updated, it is necessary to add to the file management database a flag indicating that the file is the replication, or information indicating whether the file is the original or the replica, and updating of the file must be performed on the original file.

<Access Request>

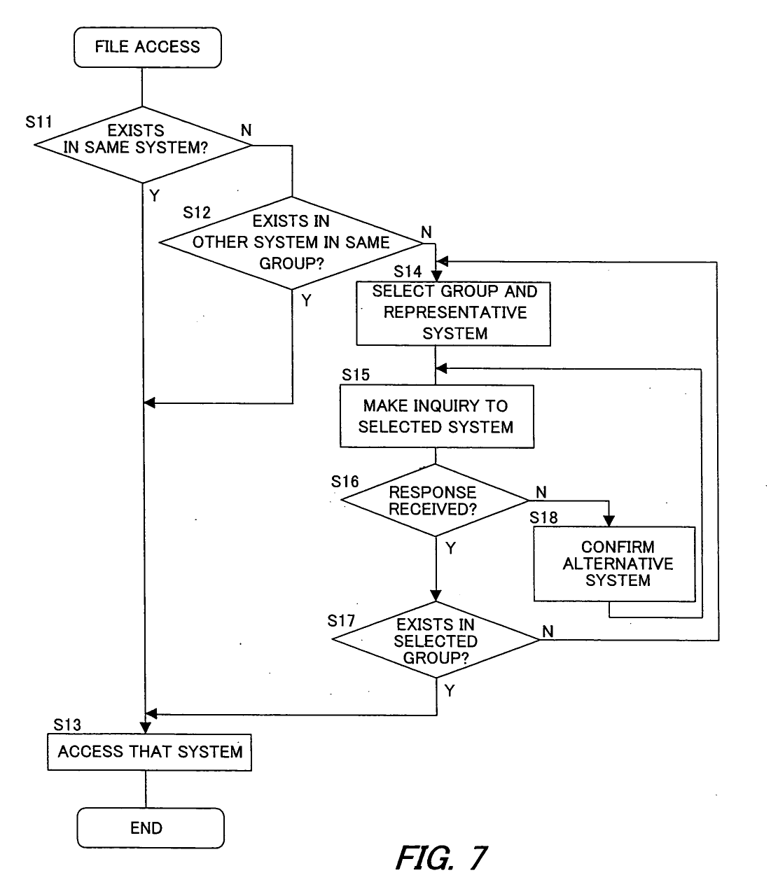

Next, referring to a flowchart of FIG. 7, explanation will be given regarding a sequence performed in response to the access request for accessing the distributed replication system.

When the client computer or the like which is connected to the network 10 in FIG. 1 searches for the file, first, an inquiry is made to the group management server 1, and then the group management server 1 responds with the location (address) of the storage system that is the representative of the first group.

The representative storage system which received the request from the client computer, searches the file management database at S11, and then when the file that was requested is there within the own storage system, the processing advances to S13 where the disk drive is accessed.

On the other hand, when the requested file is not in the own storage system, the processing advances to S12 where the file management database in the own group is searched. When the requested file is in the same group, then the identifier of the appropriate storage system is notified to the client computer. Receiving the notification, the client computer then accesses the storage system, and accesses the requested file at S13.

When the requested file is not in the same group at S12, the processing advances to S14 where the client computer makes an inquiry to the group management database 13 of the group management server 1 regarding the next group and the storage system serving as the representative thereof.

Then, at S15 an inquiry is made to the appropriate storage system. When there is a response at S16 the processing then advances to S17 where similarly to S11 and S12 it is determined whether or not the requested file is present in the file management database of the representative system of the selected group. When the file is present in the selected group, then the appropriate storage system is accessed at S13.

On the other hand, when there is no response at S16 there is a strong possibility that a failure has occurred at representative storage system in that group, so a re-inquiry is made to the group management server 1 to confirm other storage systems in that group. If there is another storage system, the processing the returns to S15 and an inquiry is made.

Furthermore, when the requested file is not present in the selected group at S17, the processing returns to S14, and a request is made to the group management server 1 for the next group and the representative storage system thereof.

In the above-mentioned sequence, the storage systems representing the groups provided to the group management database 13 of the group management server 1 are searched sequentially, and the intended file is searched and accessed.

For example, when the client computer (not shown) accesses the file “EEE”, the storage system #0 of the group A is accessed referring to the group management database 13 of the group management server 1. As shown in FIG. 2, in the file management database 24 of the storage system #0, there is no file name “EEE” in the group A, so the client computer requests the group management server 1 for the next group.

The group management server 1 returns the storage system #2 that is the representative of the group B which is the second group set in the group management database 13. When the client computer inquires to the storage system #2 about the location of the file name “EEE”, the file management database 44 notifies that the file is present in the storage system #3. In this way, the client computer sequentially makes inquiries to the storage systems that are the representatives of each group to search for the location of the file. However, once access is made, similarly to the above-mentioned conventional example, the file is cached in the cache of the storage system, or in the cache server (omitted from the diagram), thus improving the access speed from the next time.

<Adding a Storage System>

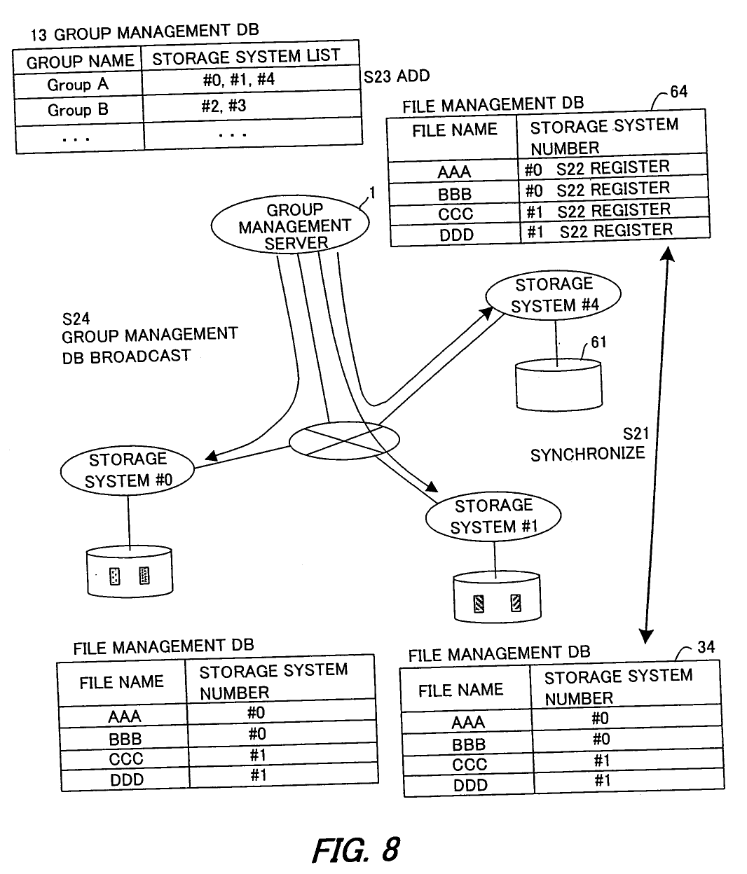

Next, referring to FIG. 8, explanation will be given regarding addition of a new storage system to the group. FIG. 8 shows an example of adding the storage system #4 to the group A.

The storage system #4, similarly to the above-mentioned storage systems, is provided with a server, a disk drive 61 and a file management database 64, and this storage system #4 is connected to the network 10.

An instruction is given to the file management database 64 to establish synchronization the file management databases of the other storage systems in the group A (here, this refers to the file management database 34 of the storage system #1) (S21). It should be noted that this instruction is given by the administrator or the like, from the group management server 1 or the storage system #4, etc.

The storage system #4 that is newly added reads the file name and the storage system number from the other file management database 34 in the same group, and registers this into its file management database 64 (S22).

Next, in the sequence shown above in FIG. 6, an operation by the administrator or the like is performed to register the storage system #4 into the group management database 13 of the group management server 1 (S23).

Since the table has been updated, the group management database 13 broadcasts to each group that the storage system #4 has been registered into the group A (S24). Accordingly, the storage systems each can recognize the storage system #4.

In the case of adding the new storage system to the group, first, the file management database is synchronized with the file management database of the group to which the file management database belongs. After that, once the storage system #4 is registered into the group management database 13 and the synchronization and the registration are complete, a broadcast is performed. Thus, even when access is made to the newly added storage system, it is nevertheless possible to respond to the request.

<Deleting a Storage System>

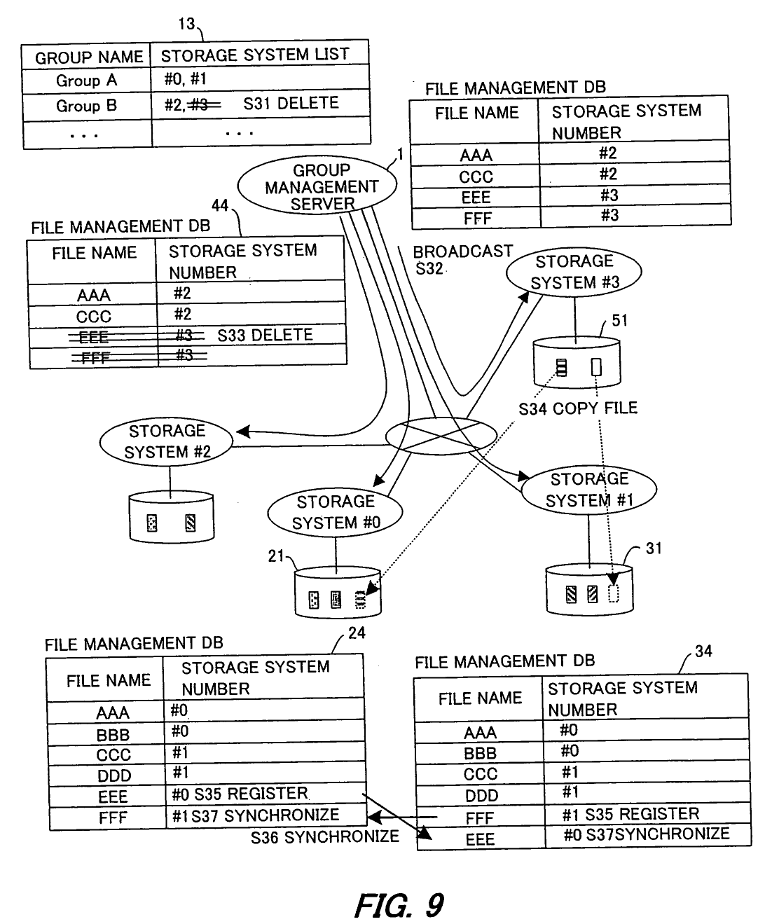

Next, referring to FIG. 9, explanation will be given regarding deletion of a storage system from the group. FIG. 9 shows an example of deleting the storage system #3 from the group B.

In the case of deleting the storage system #3, first, at S31 the storage system #3 is deleted from the group B in the group management database 13. From that point on, even when there is an access request to the group B, it is possible to prevent the group management server 1 from notifying the request source of the storage system #3.

Next, the group management database 13 then makes a broadcast to the storage systems in each group to indicate that the storage system #3 is deleted from the group B. Next, from the file management database in the same group as the storage system #3, information about the file stored in the storage system #3 is deleted. In this example, since the group B has been constituted with the storage systems #2 and #3, the record with the storage system number of “#3” is deleted from the file management database 44 of the storage system #2 (S33).

Next, files in the storage system #3 to be deleted are copied to another group to save them (S34). Here, an example is shown in which the file “EEE” is copied into the storage system #0 in the group A, and the file “FFF” is copied into the storage system #1. It should be noted that the destination to which the file is copied may be indicated by an instruction from the group management server 1 or the like.

The storage system #0 reads the file “EEE” from the storage system #3 in the group B, and writes the file “EEE” into the own disk drive 21 of the storage system #0. The storage system #1 reads the file “FFF” from the storage system #3 in the group B, and writes the file “FFF” into the own disk drive 31 of the storage system #3.

Since the file “EEE” has been added, the file management database 24 of the storage system #0 adds a record for the file “EEE”, and since the file “FFF” has been added, the file management database 34 of the storage system #1 adds a record for the file “FFF” (S35).

Then, since modifications have occurred in both the file management databases 24 and 34 in the group A, first, the file management databases 24 and 34 are synchronized with each other and the modified records are transmitted to each other, whereby identical content gets updated (S36, S37).

As described above, in the case of deleting the storage system, first, the storage system in question is deleted from the group management database 13 of the group management server 1, and then the broadcast is performed so as to prevent the systems from designating the deleted storage system in an access request. Then, the record of the storage system is deleted from the file management database in the same group as the deleted storage system, so that even when an access request is made to this group, it is possible to prevent the deleted storage system from being designated.

Furthermore, the files of the deleted storage system are copied into a different group, and the storage systems where files are stored are each registered into the file management database as the storage locations of the original file, so that even after the deleted storage system has been removed, the files can still be held within the distributed replication system, and responses can be given in response to access requests.

It should be noted that the destination to which the files of the deleted storage system are copied may be another storage system within the same group.

<Movement of Storage System>

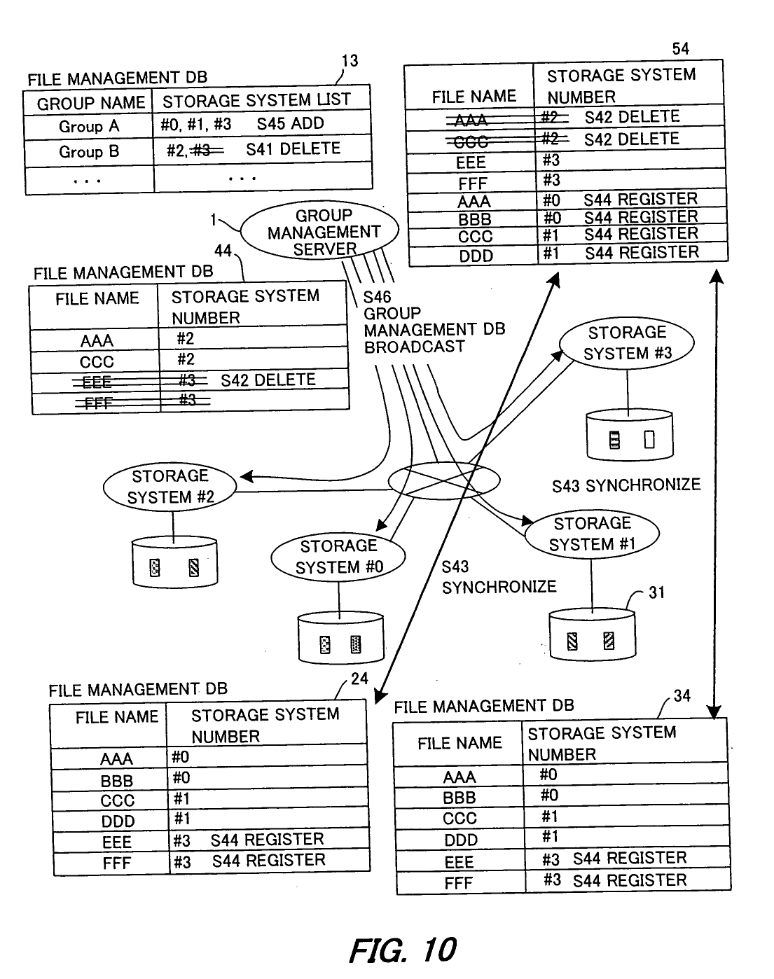

Next, FIG. 10 is referenced and explanation will be given regarding migration of a storage system between groups.

FIG. 10 shows an example where the storage system #3 belonging to the group B is moved to the group A.

First, the storage system #3 to be moved is deleted from the group B in the group management database 13 in a manner similar to the deleting process described above (S41).

Then, the records where the storage system #3 is written are deleted from all of the file management databases belonging to the group B. In this example, the records of the files “EEE” and “FFF” which are held in the storage system #3 are deleted from the file management database 44 of the storage system #2. At the same time, the records which are held in the storage systems in the group B (excluding the storage system #3 itself are deleted from the file management database 54 of the storage system #3 which is being moved (S42). Accordingly, the storage system #3 is erased from the file management database in the movement source which is the group B, and the information about the group B is erased from the file management database 54 in the storage system #3 which is being moved.

Next, synchronization is established between the file management databases 24 and 34 in the group A where the storage system #3 is being moved to, and the file management database 54 (S43). The storage system #3 stores the files “EEE” and “FFF”, so the records of the files “EEE” and “FFF” are added to the file management databases 24 and 34 in the group A and settings are configured so that these files belong to the storage system #3. At the same time, the file information on the group A is added to the file management database 54 of the storage system #3. That is, records of the files “AAA” and “BBB” in the storage system #0, and of the files “CCC” and “DDD” in the storage system #1, are added (S44).

Then, after the synchronization is complete, the storage system #3 is added to the group A in the group management database 13 (S45). After that, broadcast is performed to each of the storage systems that the storage system #3 moved to the group A (S46).

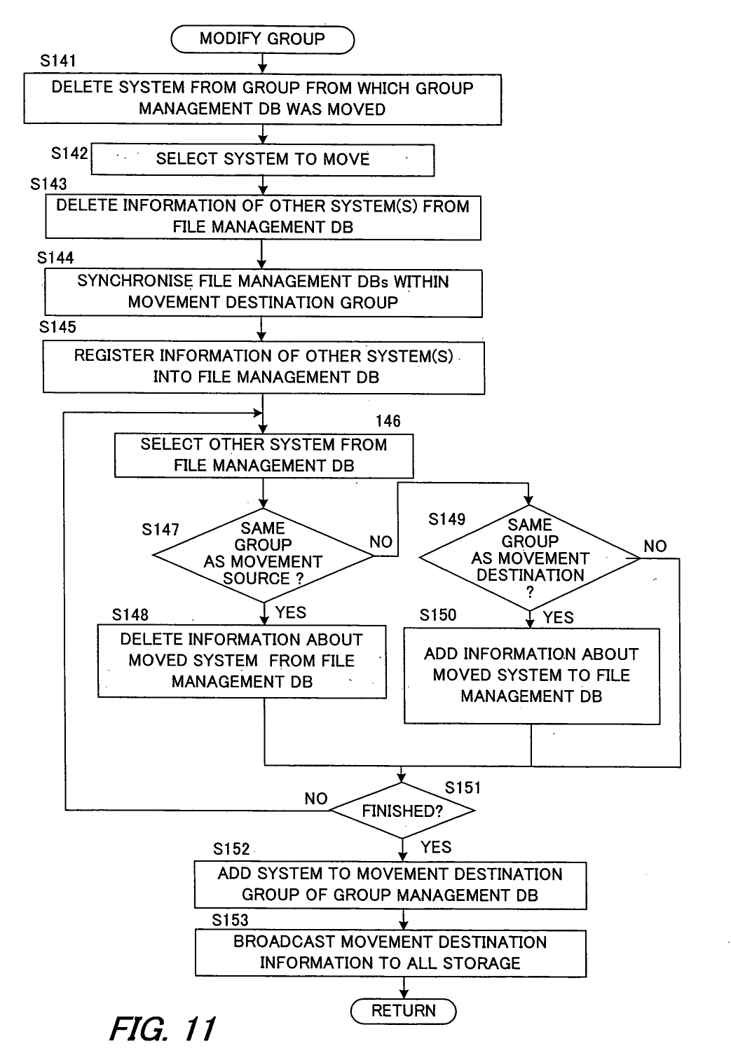

FIG. 11 is a flowchart showing an example of processing performed at the group management server 1 in the above-mentioned case where the storage system moves between groups.

First, at S141, the record of the storage system to be moved is deleted from the group management database 13. Next, at S142, the storage system to be moved is selected and then the processing advances to S143, and an instruction is given to delete the record relating to the storage system in the movement source group from the file management database (in this case, the file management database 54 of the storage system #3). After that, an instruction is given to establish synchronization with the file management database of the group that is the destination of movement, at S144.

When the synchronization is complete, at S145 an instruction is given to add the file information of the movement destination to the file management database.

Next, at S146, each storage system is accessed in sequence based on the group management database 13, and in order to arrange the migration source and migration destination environments, the storage systems are selected in sequence from the group management database 13, except for the storage system being moved.

At S147, it is determined whether or not the selected storage system is a storage system in the same group as the movement source. When it is in the same group, the processing advances to S148. Since the storage system will remain in the movement source, the information about the storage system being moved is deleted from the file management database.

Then, the processing advances to S151 where it is determined whether or not searching is complete at all the storage systems. When it is complete, the processing advances to S152. When not complete, the processing returns to S146 to select the next storage system from the group management database 13.

On the other hand, when it is judged at S147 that the selected storage system is not one in the same group as the movement source, the processing then advances to S149, where it is determined whether or not the storage system belongs to the group that is the destination of movement. If it is in the migration destination group then the processing advances to S150, where an instruction is given to synchronize the file information held by the storage system to be moved with the file management database of this storage system, and the information of the moved storage system is also registered.

Then, the processing advances again to S151, and determines whether or not access to all the storage systems is complete. It should be noted that in the determination at S149 mentioned above, when the storage system does not belong to the group that is the destination of movement, the processing advances to S151.

When the above-mentioned loop from S146 to S151 ends, the file management databases of the storage systems in the destination of movement and movement source are updated to the post-movement status.

Then, at S152, the moved storage system is added to the destination of movement group in the group management database 13. Next, at S153, a broadcast indicating that the storage system has moved is sent to all the storage systems and the processing ends.

In this way, in the case of moving the storage system between the groups, the storage system to be moved is deleted from the group management database 13, and then the file management databases at the movement source, the destination of movement, and the moved storage system are updated or synchronized, and then the storage system is added to the new group in the group management database 13 and the broadcast is performed. Accordingly, it becomes possible, without failure, to prevent the moved storage system from being accessed while it is being moved, and thus the movement can be completed smoothly.

<Recovery from Storage System Failure>

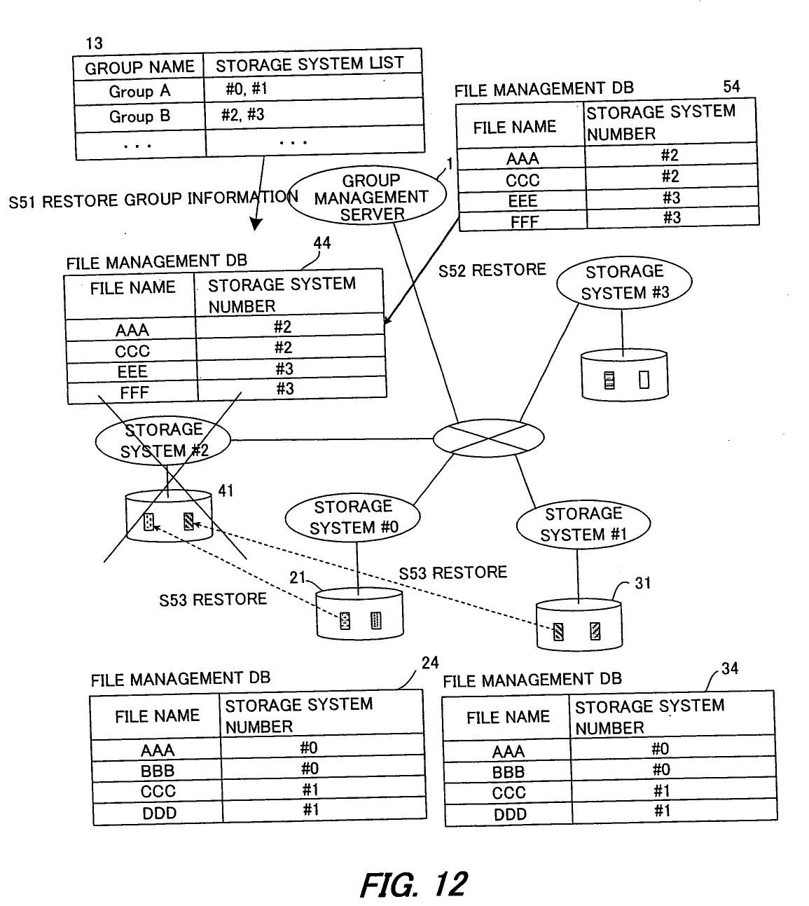

FIG. 12 shows a recovery sequence after failure has occurred in a storage system. In this example, it is assumed that the failure occurs at the storage system #2 in the group B, and after the storage system is exchanged for a new storage system, the data recover is performed. Furthermore, the storage system #2 uses replication to transfer duplicates to the storage systems #0 and #1. It should be noted that the group management server 1 holds the information of the replications.

First, the group management database 13 gives an instruction to the storage system #2, which is exchanged for the new hardware, to build the file management database 44, and provides information about the storage system of each of the groups (S51). In this case, the database 13 provides information about the storage systems #2 and #3 in the group B to which the storage system #2 belongs.

Next, the file management database 44 of the storage system #2 reads the file information from the file management database 54 of the storage system #3 in the same group B, and recovers the file management database 44 (S52).

Furthermore, the storage system #2 obtains the replication information from the group management server 1, and reads the files “AAA” and “CCC” which the storage system #2 was storing before the failure from the storage systems #0 and #1 in the replication destination group A, and writes these files onto the disk drive 41.

Thus, from the file management database 54 of the other storage system #3 in the same group, the file structure (that is file name and file location) is recovered. Furthermore, the duplicate is obtained from the other group at the replication destination. Therefore, the storage system #3 can be recovered easily and rapidly, providing a system with high resistance to failure. It should be noted that while the recovery is taking place, the group management server 1 may restrict access to the storage system #3 which is being recovered. Alternatively, while the recovery is taking place, the server 4 of the storage system #2 may restrict access requests.

As described above, each storage system is provided with the file management database, and the group management database 13 of the group management server 1, in units of groups for synchronizing the file management databases, synchronizes the file management databases in each group, thereby preventing access requests for accessing the distributed replication system from concentrating on the group management server 1.

In addition, the storage systems in each group have the same synchronized file management databases, and so no matter which storage system the failure occurs in, the file management database of a storage system in the same group may be used to perform the recovery easily and rapidly. This improves the reliability of the distributed replication system.

Then, the replications from the other groups are stored in each group and can be provided in response to access requests. This prevents the access request from the client computer and the like from being issued to many groups, and thus improves the access speed.

Furthermore, storing the replications into the other groups improves disaster tolerance and improves the reliability of the distributed replication system.

Furthermore, since the file management databases of all the storage systems are identical within each of the groups, the access request only has to be made to one storage system in each group (e.g., the representative storage system), which reduces the number of times inquiries are made, and reduces network traffic and the load on the management server 1.

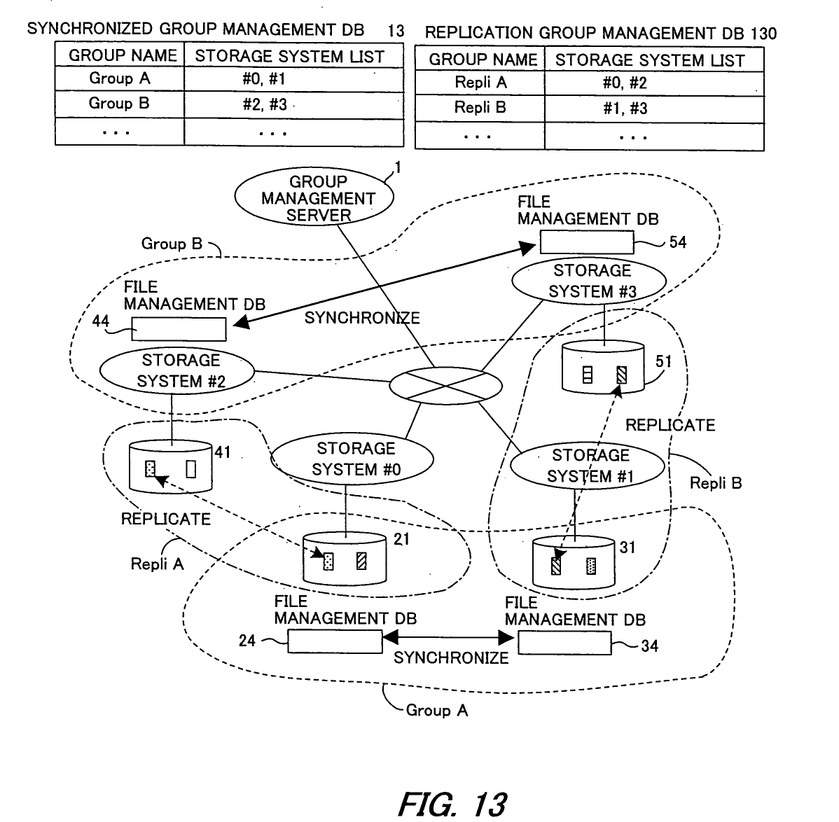

FIG. 13 shows an example of the group management server 1 limiting the above-mentioned replication information.

The group management server 1, in addition to the group management database 13 that synchronizes the file management databases in each of the storage systems, also has a replication group management database 130 set with the locations where each of the storage systems are replicated.

When the groups A and B synchronizing the file management databases are treated as a synchronization group as described above, the replications of the storage systems in each synchronization group are grouped so that the other entities transferring to storage systems in other synchronization groups are not the same, forming a “replication group”. The replication group management database 130 managing the replication group is set in advance by the administrator or the like.

The replication group management database 130 is constituted by a list of replication group names and storage systems. For example, as shown in the diagram, a replication group A (“Repli A” in the diagram) has the storage system #0 in a synchronization group A, and the storage system #2 in a synchronization group B. A replication group B has the storage system #1 in the synchronization group A, and the storage system #3 in the synchronization group B.

Each storage system obtains the replication location from the replication group management database 130, and transfers their duplicates.

For example, when the file in the disk drive 21 is updated, the storage system #0 transfers the replication to the storage system #2 in the synchronization group B, according to the definition of the replication group A. Similarly, the storage system #2 in the synchronization group B makes a replication to the storage system #0 in the synchronization group A.

On the other hand, the storage system #1, which is in the same synchronization group A as the storage system #0, belongs to the replication group B, which is different from the storage system #0, and makes the replication to the storage system #3 in the synchronization group B.

In other words, the replication groups are configured such that the storage systems that constitute the replication groups are not in the same synchronization groups. This enables the duplicates of the files in each storage system to be transferred to differential synchronization groups and provided in response to the read request. This reduces the number of synchronization groups to be accessed (i.e., the number of times access is made) when the read request is received, and enables the response to be made to the access request in an efficient manner.

Furthermore, since the replication is necessarily stored in another synchronization group, disaster tolerance is improved. In particular, the locations where the storage systems in the same group are replicated are in other synchronization groups and at different storage systems, thus increasing disaster tolerance.

Furthermore, the replications can be managed on the file management database of each storage system as described above, and even when the overall number of files in the distributed replication system is increased, an increase in the labor required for management can be prevented.

It should be noted that the above descriptions showed an example in which two storage systems are provided in the replication group, but three or more storage systems may be set, and the storage systems may hold replications of each other, further improving disaster tolerance.

### FIRST MODIFIED EXAMPLE

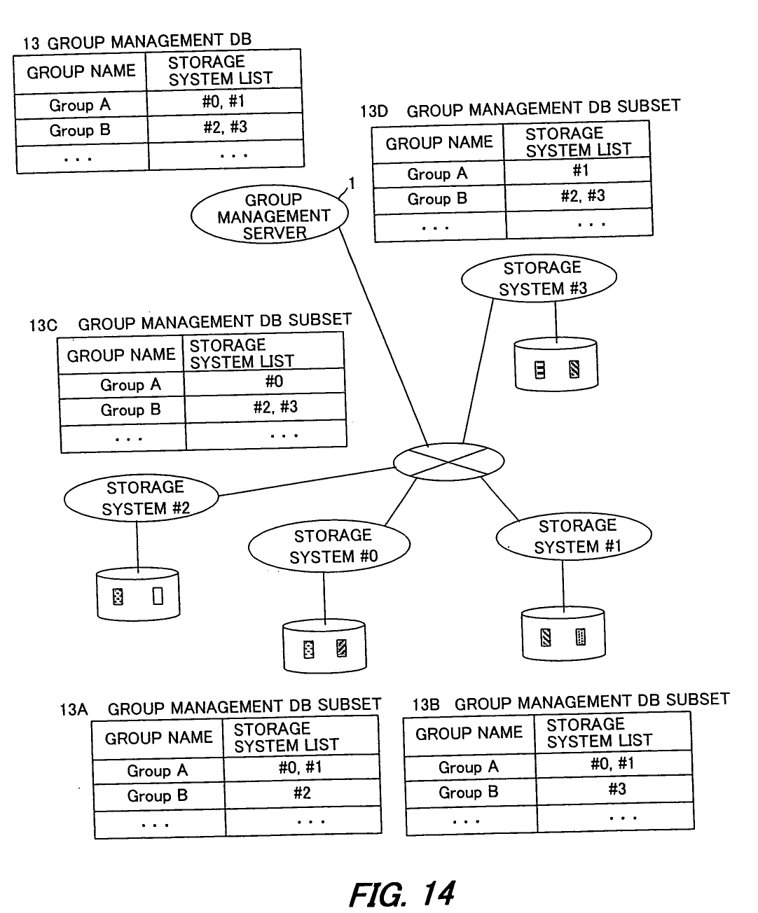

FIG. 14 shows a subset of the group management database 13 provided to the storage system in each group.

Group management database subsets 13A-13D, which are provided to the storage systems #0-#3 of the groups A and B, respectively, are identical with respect to the storage system lists within their own groups, but one representative storage system is set for the storage systems of the other groups.

For example, in the storage system #0 of the group A, in the group management database subset 13A, for the neighboring group B, the storage system #2 is set as the representative storage system. In the storage system #1 in the same group A, in the group management database subset 13B, for the neighboring group B, the storage system #3 is set as the representative storage system.

By setting a representative storage system of another group that is different for each storage system, when access is made form another group or the like, the representative storage system different for each storage system is replied. This prevents load increase due to access concentrating on a particular storage system, and thus distributes the load.

Furthermore, even when a failure has occurred in the group management server 1, the access point can be searched for by making inquiry to any of the storage systems, thus improving disaster tolerance.

Conversely, when the failure occurs at the representative storage system of another group, the storage system that received the access request can make an inquiry to the group management database 13 of the group management server 1, and the address of the other storage system can be replied.

It should be noted that while not being shown in the diagrams, each storage system may have a group management database and synchronization may be established between the groups and within each group. In such a case, the group management database 13 becomes unnecessary, and thus the construction of the distributed replication system can be made simple.

### SECOND MODIFIED EXAMPLE

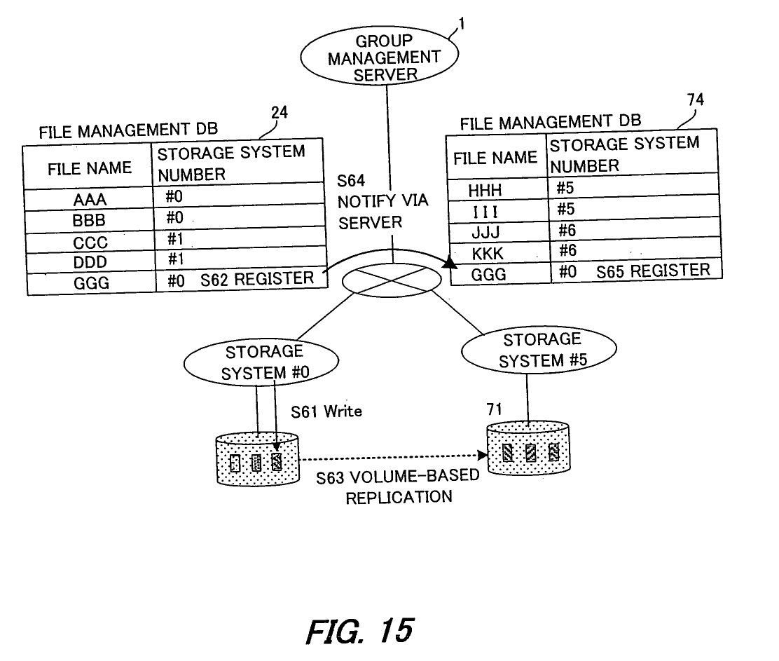

FIG. 15 shows the replications made between groups as being made not in units of files as described above, but in units of volumes.

This example is configured such that the storage system #0 in the group A makes a volume-based replication into the storage system #5 in group X. It should be noted that the storage system #5, similarly to the other storage systems shown in FIG. 1 mentioned above, is provide with a server (not shown), a disk drive 71, and a file management database 74.

When an update request is received at the storage system #0, the storage system #0 writes the file “GGG” into its own disk drive 21 (S61).

At the storage system #0, the name of the file “GGG” and the identifier of the storage system where it was stored, are registered into the file management database 24 (S62).

Next, the storage system #0 transfers the content of the disk drive 21 to the disk drive 71 of the storage system #5, and executes the volume-based replication (S63).

Next, the storage system #0 notifies the file that was modified, to the server of the storage system #5, from the server 2 (S64).

Next, the server of the storage system #5, based on this notification, registers the file “GGG” that was modified into the file management database 74 (S65).

In this way, when there is an update to the files at the storage system #0, the volume-based replication is performed form the disk drive 21 to the disk drive 71, and after the file management database 24 is updated, the server 2 (shown in FIG. 1) of the storage system #0 notifies the file information to the server of the storage system #5, thereby updating the file management database 74 in the storage system #5.

In the case of the volume-based replication, the file information is notified separately, thereby updating the file management database of the storage system #5 storing the replication.

### THIRD MODIFIED EXAMPLE

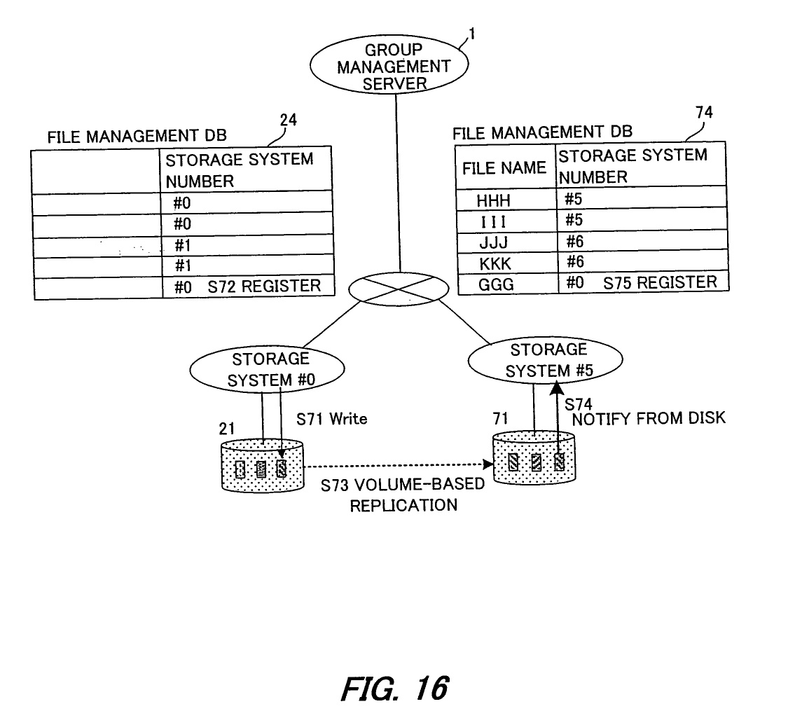

FIG. 16 shows the notification of the file in the second modified example being made from the disk drive, and other aspects are similar to the second modified example.

In this case, another interface is provided between the storage system's server and disk drive, and when the volume-based replication between disk drives is complete, the disk drive 71 notifies the modification to the server side.

When the storage system #0 has been updated, similarly to S61-S63 in the second modified example, the storage system #0 writes the file “GGG” into its own disk drive 21, and then updates the file management database 24. The storage system #0 then transfers the content of the disk drive 21 to the disk drive 71 of the storage system #5, and executes the volume-based replication (S71-S73).

Next, the disk drive 71 of the storage system #5 notifies the file that was modified, to the server (S74). The server, based on this notification, registers the file “GGG” that was modified into the file management database 74 (S75).

### FOURTH MODIFIED EXAMPLE

In the above-mentioned embodiments, explanations have been given regarding examples in which each storage system is constituted with a server and a disk drive, but the servers 2-5 may be replaced with a controller to create a NAS (Network Attached Storage).

Alternatively, a NAS and a SAN (Storage Area Network) may be incorporated within the storage system.

While the present invention has been described in detail and pictorially in the accompanying drawings, the present invention is not limited to such detail but covers various obvious modifications and equivalent arrangements, which fall within the purview of the appended claims.

1. A file management method for distributed storage systems, for managing files stored in a plurality of storage systems arranged in a distributed manner, the file management method comprising the processes of:
allocating the storage systems to a plurality of groups;
synchronizing file management information indicating locations of all the files in the storage systems belonging to the groups, between storage systems of the same group; and
determining a storage system to access based on the file management information when the group has received an access request for a file.

2. The file management method for distributed storage systems according to claim 1, wherein the file management information includes locations of all the files stored in the storage systems in the same group, the method comprising the processes of:
when the group has received the access request for the file, searching for the storage system based on the file management information of the same group; and
when the file to be accessed does not exist in the same group, inquiring about the file in another group.

3. The file management method for distributed storage systems according to claim 1, wherein:
the process of allocating the storage systems to the plurality of groups comprises:
a group where the file management information is synchronized; and
a replication group for transferring a replica between storage systems of different groups; and
the storage systems of different groups are allocated to the replication group.

4. The file management method for distributed storage systems according to claim 1, further comprising the processes of:
transferring a replica from the storage system to another group;
storing the transferred replica into a storage system; and
adding the stored replica to the file management information of the other group.

5. The file management method for distributed storage systems according to claim 4, wherein:
the file management information has an identifier indicating the location of the file, and information indicating whether the file stored in the storage system is an original file or a replica file; and
when the group has received the access request for the file and the access is a read request, the location of one of the original file and the replica file is notified, and when the access is an update request, the location of the original file is notified.

6. The file management method for distributed storage systems according to claim 1, further comprising the processes of:
when modifying the group to which the storage systems belong, deleting information relating to old group file location from the file management information, and adding information relating to new group file location to the file management information; and
notifying all groups that the modification has occurred.

7. The file management method for distributed storage systems according to claim 3, further comprising the processes of:
when recovering the storage system from a failure, obtaining the file management information of another storage system in the same group; and
obtaining the file stored in the other group.

8. A distributed storage system, comprising:
a plurality of storage systems which are constituted by a server that receives an access request for a file and a disk drive that stores a file and arranged in a distributed manner;
a group identification module that identifies a group set for each storage system;
a file management information storing module that shares locations of files stored in storage systems within the same group;
an information updating module that, when the access request for the file is an update request, writes the file being requested into the disk drive, and updates information about the file in the file management information storing module; and
a replication module that transfers a replica of the file to the storage system belonging to another group.

9. The distributed storage system according to claim 8, wherein:
the replication module performs copies between disk drives in units of volumes; and
the server notifies the server belonging to another group to which the copy is created that the copy has occurred between disk drives.

10. The distributed storage system according to claim 8, wherein:
the replication module performs copies between disk drives in units of volumes; and
the disk drive to which the copy is created is provided with an interface that provides notification to the server at a copy destination.

11. A distributed storage system, comprising:
a plurality of NAS which are constituted by a control module that receives an access request for a file and a disk drive that stores a file and arranged in a distributed manner;
a group identification module that identifies a group set for each NAS;
a file management information storing module that shares locations of files stored in NAS within the same group;
an information updating module that, when the access request for the file is an update request, writes the file being requested into the disk drive, and updates information about the file in the file management information storing module; and
a replication module that transfers a replica of the file to the NAS belonging to another group.

12. The distributed storage system according to claim 11, wherein:
the replication module performs copies between disk drives in units of volumes; and
the control module notifies the control module belonging to another group to which the copy is created that the copy has occurred between disk drives.

13. A storage system, comprising:
a disk drive that receives a file access request and performs one of reading and updating a requested file;
a group information storing module that stores group information that is set in advance;
a file management information storing module that stores locations of files stored in storage systems within the same group;
an information updating module that, when writing the file to the disk drive, updates file information in the file management information storing module;
a synchronization module that synchronizes file management information storing modules with storage systems in the same group; and
a replication module that transfers a replica of the file to a storage system in another group that is set in advance.

14. A program for managing files stored in storage systems, the program causing a computer to execute the procedures of:
allocating the storage systems to a plurality of groups;
synchronizing, between other storage systems in the same group, file management information indicating locations of all files in the storage systems belonging to the allocated groups; and
when there is an access request for the file, determining a storage system to access based on the file management information.

15. The program according to claim 14, further causing the computer to execute the procedures of:
when the access request is for an update, writing the file; and
transferring a replica of the file that has been written to a storage system in a different group.

16. The program according to claim 14, further causing the computer to execute the procedures of:
writing a replica of the file transferred from the storage system in the different group; and
adding information about the file to the file management information.
